(19) United States
(12) Patent Application Publication
(10) Pub. No.: US 2017/0046049 A1
(43) Pub. Date: Feb. 16, 2017

(54) SYSTEMS, METHODS, AND STORAGE MEDIA ASSOCIATED WITH FACILITATING INTERACTIONS WITH MOBILE APPLICATIONS VIA MESSAGING INTERFACES

(71) Applicant: DISNEY ENTERPRISES, INC., Burbank, CA (US)

(72) Inventors: Alif Khalfan, Burbank, CA (US); David Feder, Burbank, CA (US); Patrick Millegan, Burbank, CA (US)

(73) Assignee: DISNEY ENTERPRISES, INC.

(21) Appl. No.: 14/826,931

(22) Filed: Aug. 14, 2015

(51) Int. Cl. G06F 3/0484; H04W 4/00; G06F 3/0481; H04M 1/725

(52) U.S. Cl. CPC G06F 3/04842; H04M 1/72552; H04M 1/72525; H04W 4/003; G06F 3/04817

(57) ABSTRACT

Interactions with mobile applications may be facilitated via messaging interfaces. A first messaging interface may be presented via a first computing platform including a first entry field displaying first messaging content available for entry and/or selection by a first user. The first messaging content may include a first icon. The first icon may be selectable by a second user via the messaging feed displayed via a second communication field of a second computing platform. Selection of the first icon via the messaging feed displayed via the second communication field of the second computing platform may effectuate an interaction with a mobile application occurring on the second computing platform.

### FIELD OF THE DISCLOSURE

This disclosure relates to systems, methods, and storage media associated with facilitating interactions with mobile applications via messaging interfaces.

### BACKGROUND

Conventional social interactions on mobile platforms are generally less viral than on web-based platforms, often making them less effective at driving installs, user re-engagement, and generating viral buzz. The friction for sending viral messages is typically high, usually requiring users to be inside a specific application (e.g., a game application) in order to interact socially with other users. Even then, users may be limited to their friends currently engaging with the specific application, or those who have connected via Facebook™. Low Facebook Connect™ rates and a lack of an easily-accessible external-facing social graph may make virality presently difficult for mobile applications.

Currently, many social interactions may be handled through Facebook. A user may receive a Facebook notification regarding a social event, which may open the Facebook application on a mobile platform. Tapping on the notification within the Facebook application may then switch over to the actual application where the user can actually complete the social interaction. This may be problematic for at least two reasons. First, only about 10% of users actually connect to Facebook in the first place, which may severely limit a potential social pool. Second, the friction involved in moving across so many different applications unrelated to the core social experience may be high.

### SUMMARY

One aspect of the disclosure relates to a system configured for facilitating interactions with mobile applications via messaging interfaces. Indeed, to make social interactions more easily sharable on mobile platforms, exemplary implementations may embed social interactions into already established viral and social experiences such as messaging and chat. By adding keys or icons to a special keyboard that have deep-linked, app-specific social functionality, some implementations may allow users to perform various social interactions. For example, inviting a friend to install an app or sending gifts with one tap, directly from a chat screen, without needing to open the corresponding application and proceed to an appropriate social screen.

By way of non-limiting example, a user playing Star Wars Commander may download and install a special keyboard that has customized buttons or icons deep-linked to specific social actions for that application. In addition to general alphanumeric keys, the special keyboard may include buttons or icons dedicated to inviting friends and sending troops (actions regularly performed directly in the Star Wars Commander application). These icons may be in the form of text, animated images, and/or other types of icons. Responsive to a user tapping an “invite friends” icon, for example, a rich visual Star Wars Commander icon may be sent as a chat message to a recipient user. Responsive to the recipient user tapping on the icon in the message feed, the recipient user's computing platform may be directed to the Commander page on the App Store to install the game.

By way of another non-limiting example, a “send troops” button or icon may immediately send troops to a recipient user's account. Sending troops may be an action that is regularly performed directly in the game. Responsive to the recipient user tapping a “troops sent” icon in the message feed, the recipient user's computing platform may be directed to the application with the troop gift claimed automatically. Thus, exemplary implementations may involve significantly less friction than existing technologies. After installing a special keyboard, a user may easily participate in social and other interactions without leaving their messaging application.

In some implementations, the system may include one or more hardware processors, which may be configured by machine-readable instructions to provide a first messaging interface for presentation via a first computing platform associated with a first user. The first messaging interface may include a first entry field and a first communication field. The first entry field may display first messaging content available for entry and/or selection by the first user. The first communication field may display a messaging feed that reflects a communication session between the first computing platform and a second computing platform associated with a second user. The second computing platform presenting a second messaging interface may include a second communication field displaying the messaging feed. The communication session may include first messaging content previously entered and/or selected by the first user via the entry field and second messaging content previously entered and/or selected via the second computing platform.

The one or more hardware processors may be configured by machine-readable instructions to receive first messaging content entered and/or selected via the first entry field of the first messaging interface presented via the first computing platform.

The one or more hardware processors may be configured by machine-readable instructions to update the messaging feed to present the received first messaging content. The updated messaging feed being displayed via the first communication field of the first computing platform and the second communication field of the second computing platform.

The first messaging content available for entry and/or selection by the first user may include one or more icons including a first icon. The first icon may be selectable by the second user via the messaging feed displayed via the second communication field of the second computing platform. Selection of the first icon via the messaging feed displayed via the second communication field of the second computing platform may effectuate an interaction with a mobile application occurring on the second computing platform.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured for facilitating interactions with mobile applications via messaging interfaces, in accordance with one or more implementations.

FIG. 2 illustrates an exemplary implementation of a server of the system of FIG. 1.

FIG. 3 illustrates an exemplary implementation of a computing platform of the system of FIG. 1.

FIGS. 4 and 5 illustrate an exemplary implementation of a messaging interface of a first computing platform.

FIGS. 6 and 7 illustrate an exemplary implementation of a messaging interface of a second computing platform.

FIG. 8 illustrates an exemplary implementation of an application interface of the second computing platform.

FIG. 9 illustrates a method for facilitating interactions with mobile applications via messaging interfaces, in accordance with one or more implementations.

FIG. 10 illustrates a method for facilitating interactions with mobile applications via messaging interfaces, in accordance with one or more implementations.

### DETAILED DESCRIPTION

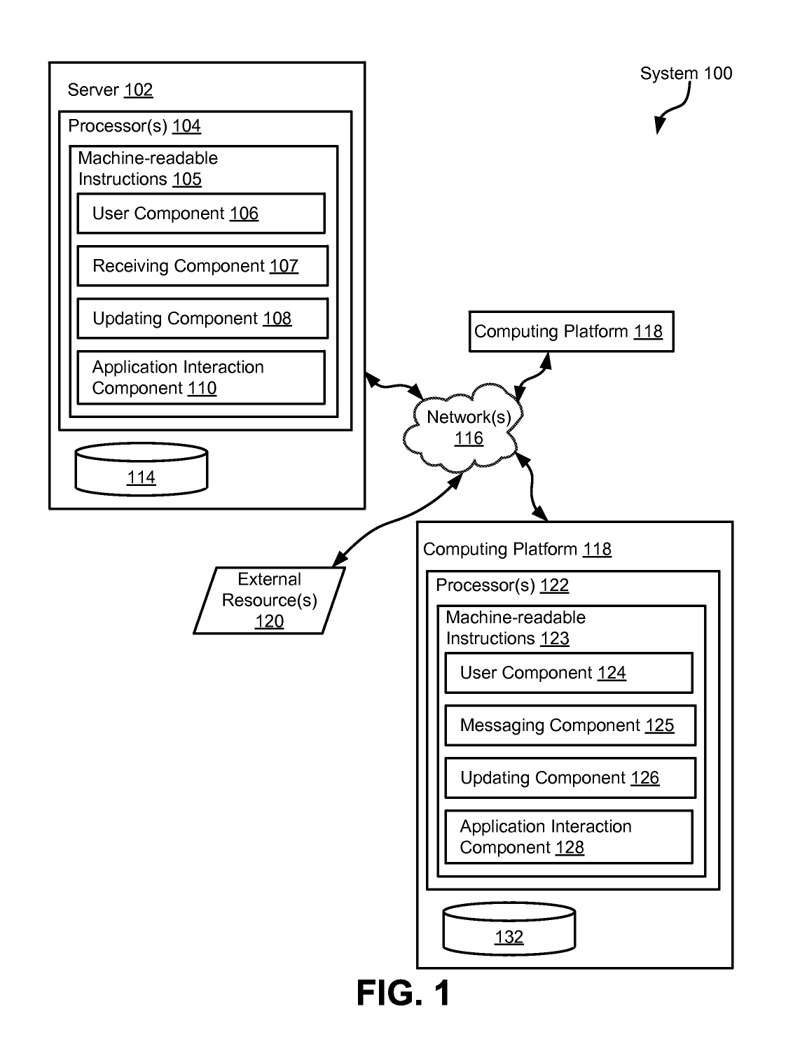

FIG. 1 illustrates a system 100 configured for facilitating interactions with mobile applications via messaging interfaces, in accordance with one or more implementations. The messaging interfaces may be presented on computing platforms 118. In some implementations, communication sessions between computing platforms 118 may be established over one or more networks 116. A network 116 may include, for example, the Internet, a cellular network, local area network, and/or other networks. In some implementations, a host may route messaging content communicated between computing platforms 118 in accordance with the communication sessions. The host may include, for example, server 102 and/or other host.

Computing platforms 118 may include one or more of a cellular telephone, a smartphone, a laptop, a tablet computer, a desktop computer, a television set-top box, smart TV, a gaming console, a client device, and/or other device suitable for the intended purpose(s) presented herein.

In some implementations, execution of a messaging application may be facilitated by information exchange among the computing platforms 118, server 102, and/or other information source. By way of non-limiting example, information defining the messaging application and/or operations of the messaging application may be provided to the computing platforms 118 based on information determined at server 102. For example, the server 102 may serve information describing functions, features, views of an interface of the messaging application, and/or other information to the computing platforms 118 according to client/server architecture. The computing platforms 118 may present views of the interface at displays of the computing platforms 118 based on the served information and/or other information.

In some implementations, information defining the messaging application and/or operations of the messaging application may be provided to the computing platforms 118 based on information determined locally at the computing platforms 118. For example, the computing platforms 118 may store machine-readable instructions 123 which, when executed, determine information describing functions, features, views of an interface of the messaging application, and/or other information associated with the messaging application. The computing platforms 118 may be configured to assemble and/or present views of the interface in displays of the computing platforms 118 based on the locally determined information, and/or other information. In some implementations, the messaging application may operate on the computing platforms 118 based on a combination of information served to the computing platforms 118, information determined locally at the computing platforms 118, and/or other information.

It is noted that descriptions directed to “a” computing platform, a “first” computing platform, a “second” computing platform, and/or other computing platform are to be understood as being descriptions for any one of the one or more computing platforms 118 included in the system. For example, descriptions of configurations of computing platforms 118 may be directed to a single recitation of “the” or “a” computing platform for clarity. However this is for clarity and illustration purposes only, and it is to be understood that other computing platforms 118 may be similarly configured.

A computing platform 118 may include one or more physical processors 122 configured to execute machine-readable instructions 123. The machine-readable instructions 123 may be stored in electronic storage 132 of the computing platform 118, and/or other storage location. The electronic storage 132 may include, for example, non-transitory computer-readable storage media. The machine-readable instructions 123 may include one or more of a user component 124, a messaging component 125, an updating component 126, an application interaction component 128, and/or other components. The machine-readable instructions 123 may be executable by the computing platform 118 to facilitate interactions with mobile applications via messaging interfaces.

In some implementations, one or more portions of the machine-readable instructions 123 may comprise information downloaded to the computing platform 118. By way of non-limiting example, the computing platform 118 may download at least part of the machine-readable instructions 123 from the server 102, an external resource 120, and/or other sources. For example, the machine-readable instructions 123 may be downloaded to the computing platform 118 as part of a third party messaging application (e.g., an “app”). The computing platform 118 may obtain the machine-readable instructions 123 in other ways.

In some implementations, the user component 124 may be configured to access and/or manage one or more user profiles and/or user information associated with users of computing platform 118. The one or more user profiles and/or user information may include information stored by computing platform 118, server 102, one or more other computing platforms 118, and/or other storage locations. The user profiles may include, for example, information identifying users (e.g., a username or handle, a number, an identifier, and/or other identifying information) within the messaging application and/or communication session, security login information (e.g., a login code or password), subscription information, virtual (or real) currency account information (e.g., related to currency held in credit for a user), virtual inventory information (e.g., virtual inventories of virtual items associated with the users that include one or more virtual items available for the users in a game played in a messaging feed), relationship information (e.g., information related to relationships between users in the messaging application), usage information (e.g., a login history indicating the frequency and/or number of times the user logs-in to the user accounts), demographic information associated with users, communication history, information stated by users, browsing history of users, a computing platform identification associated with a user, a phone number associated with a user, and/or other information related to users.

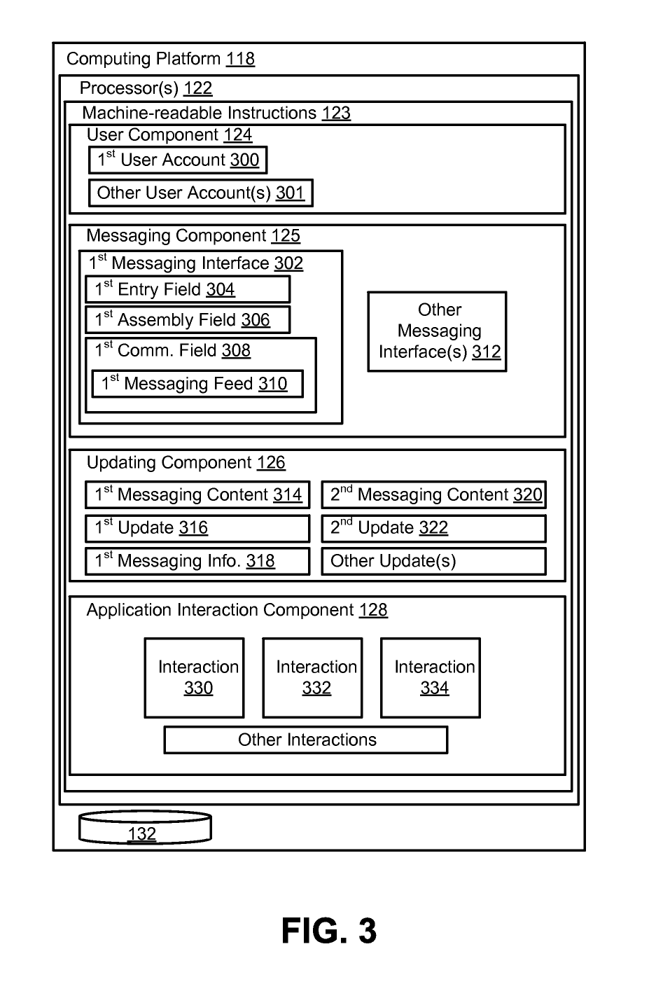

By way of non-limiting illustration in FIG. 3, the user component 124 may be configured to manage a first user account 300 associated with one or more users of the computing platform 118. The user component 124 may be configured to manage other user accounts 301 associated with one or more other users of the computing platform 118.

Returning to FIG. 1, in some implementations, the messaging component 125 may be configured to effectuate presentation of a messaging interface on a display of the computing platform 118. The messaging interface may include an entry field, an assembly field, a communication field, and/or other fields.

The entry field may be configured to display messaging content available for entry and/or selection by users. Messaging content may include one or more of text, an image, a video, audio, and/or other content. Text may include one or more of alphanumeric characters, symbols, and/or characters of one or more other writing systems. Images may include photographs, pictures, and/or graphical icons. Graphical icons may include one or more of an emoticon, an emoji, a sticker, a game icon, and/or other graphical icons. Graphical icons may be static and/or dynamic. For example, a dynamic icon may become briefly animated in a messaging feed. However, the dynamic nature of a graphical icon may end after the brief animation. The dynamic icon may become a static icon displayed in a messaging feed.

In some implementations, messaging component 125 may be configured to facilitate downloading a special keyboard to a given computing platform 118. The special keyboard may include a graphical representation of a physical keyboard such that entry occurs by touching areas of the keyboard using a touchscreen. The special keyboard may include alphanumeric characters, images, icons, emojis, and/or other messaging content such as described further herein. The special keyboard may be downloaded from server 102 and/or other locations. The special keyboard may be downloaded as a component of an application that is downloaded to the given computing platform 118. The special keyboard may be downloaded as a separate component. The special keyboard may be available as a selectable option from among several keyboards available for use on computing platform 118. The special keyboard may include messaging content that is otherwise unavailable for entry and/or selection by an entry field of a messaging interface. For example, the special keyboard may include messaging content that is not available on a standard keyboard of a messaging application that is native to the given computing platform 118. In some implementations, messaging content available for entry and/or selection via the special keyboard may include one or more application-type icons. A given application-type icon may be configured to facilitate interactions with mobile applications via messaging interfaces, as described further herein.

In some implementations, an emoticon may comprise a set of text characters and/or symbols arranged to resemble an image (e.g., a face, a picture, and/or other image). In some implementations, an emoji may comprise an ideograph and/or other graphic symbol. In some implementations, emoticons may correspond to one or more emojis. By way of non-limiting example, entry and/or selection of an emoticon via the entry filed may result in a corresponding emoji being presented in a messaging feed.

In some implementations, the entry and/or selection of messaging content may update a messaging feed displayed in the communication field of the messaging interface. In some implementations, the entry and/or selection of messaging content may facilitate updates of messaging feeds displayed on one or more other computing platforms associated with a communication session, and/or may facilitate other operations.

An entry field may include various messaging content types available for entry and/or selection by users. In some implementations, the entry field may include one or more pages, tabs, windows, and/or portions that allow a user to choose among various available content types and/or entry and/or selection methods. In some implementations, the entry field may include an array of different messaging content types within a single display that may be available for entry and/or selection (e.g., a display including different emojis, icons (including application-type icons), text, and/or messaging content).

In some implementations, text-type messaging content may be entered and/or selected via a keyboard (e.g., a standard keyboard, a native keyboard, a special keyboard, and/or other keyboards), voice input, and/or other user input method.

In some implementations, graphical icon-type messaging content may be entered and/or selected by providing input into the entry field corresponding to a displayed location of the graphical icons. By way of non-limiting example, an entry field may display an array, grid, and/or other display of various graphical icons. A user may select a given graphic icon by one or more available input mechanisms. Input mechanisms may include, for example, physical interface elements (e.g., depressible buttons, keys, and/or other elements), a touch-sensitive display, an input device included in or coupled with the computing platform 118 (e.g., a mouse, a joystick, keyboard, and/or other device), gesture recognition input, voice input, and/or other input mechanism. By way of non-limiting example, a user may hover a cursor over a display of a graphical icon and select the icon using an input mechanism (e.g., clicking a mouse). By way of non-limiting example, a user may finger-tap a portion of a touch-sensitive display that shows a desired graphical icon.

In some implementations, a user may select a graphical icon using text-based entry. By way of non-limiting example, a user may input a textual portrayal of a graphic icon (e.g., emoticon) into the assembly field using symbols present on a keyboard. When the user submits the input (e.g., selects a “send” option), the communication field may be updated to include a corresponding graphical icon.

In some implementations, an assembly field may reflect messaging content entered and/or selected from the entry field. The assembly field may show an assembly of the entered and/or selected messaging content based on sequential entry and/or selection of the messaging content by a user. In some implementations, the assembly field may be configured to perform one or more functions of the messaging application including automatic spelling corrections (e.g., “autocorrect”), word predictions, and/or other features and/or functions. In some implementations, the assembly field may include one or more pages, tabs, windows, selectable interface elements, and/or portions that allow a user to choose among various available content types and/or entry and/or selection mechanisms available within the entry field.

In some implementations, the communication field may display a messaging feed that reflects a communication session between the computing platform 118 and one or more other computing platforms. The messaging feed may include messaging content previously entered and/or selected by a user of the computing platform 118 and/or other users of other computing platforms. In some implementations, the messaging feed may be updated based on entry and/or selection of messaging content by the user via the entry field and/or based on entry and/or selection of a “send” interface element included in the assembly field. In some implementations, user entry and/or selection of messaging content from the entry field may automatically update the messaging feed based on the entries and/or selections. In some implementations, entry and/or selection of messaging content from the entry field may first be reflected by instances of the messaging content appearing in an assembly area of the assembly field (e.g., as a preview). The messaging feed may be updated to include messaging content based on entry and/or selection of an interface element included in the assembly field (e.g., a selectable element labeled “send,” and/or other term).

Messaging content entered and/or selected by the various users participating in the communication session may be distinguished by separating messaging content within the messaging feed and/or otherwise distinctively associating messaging content with the appropriate user that submitted the content. By way of non-limiting example, users may be represented by identifying text, avatars, and/or graphical user icons shown in the messaging feed. Messaging content entered and/or selected by individual ones of the users may be displayed in separate chat bubbles that are connected to and/or otherwise distinctively associated with user representations in the messaging feed.

In some implementations, incoming messaging content may cause one or more previously entered and/or selected content displayed in the messaging feed to scroll to a new position within the messaging feed to make room for the new incoming content. In some implementations, icons presented in messaging feeds may be displayed the same as or similar to other messaging content (e.g., text content) presented in a feed (e.g., icons may also scroll within the messaging feed based on new content being introduced into the feed). Messaging feeds may present messaging content in other ways.

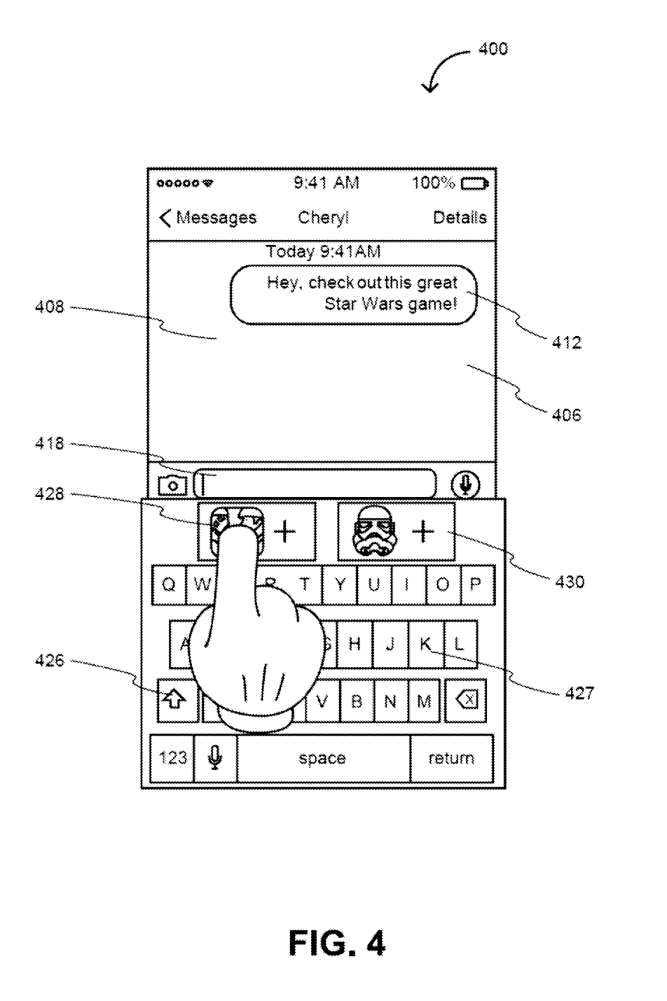

By way of non-limiting illustration in FIG. 4, an exemplary implementation of a messaging interface 400 of a first computing platform is shown. The first computing platform may comprise, for example, a handheld smartphone and/or other computing platform. The first computing platform may include one or more physical processors (now shown in FIG. 4) configured to execute machine-readable instructions to perform a method for facilitate interactions with mobile applications via the messaging interface 400.

The messaging interface 400 of a messaging application may be presented on the first computing platform. The messaging interface 400 may include a first communication field 406, a first assembly field 418, a first entry field 426, and/or other fields. The first entry field 426 may be configured to display messaging content available for entry and/or selection by a user of the first computing platform. The current depiction of the first entry field 426 shows a special keyboard 427 including an array of graphical icons available for entry and/or selection by a user. However, other implementations of the first entry field 426 may include other messaging content types. Different implementations of the first entry field 426 may include displaying a keyboard-type entry mechanism, a graphical icon array, and/or other implementations.

In some implementations, the graphical icons available for entry and/or selection by a user may be determined based on subscription information associated with a user account (e.g., based on user component 124). By way of non-limiting example, users may purchase and/or acquire one or more graphical icons to make the one or more graphical icons available to the user. By way of non-limiting example, users may purchase graphical icons via a virtual shop (not shown). Users may make purchases with real (or virtual) currency. In some implementations, a standard and/or base set of graphical icons may be provided to one or more users who participate in the messaging application (e.g., download the messaging app). In some implementations, graphical icons may be provided based on applications installed on a given computing platform.

Graphical icons shown in the first entry field 426 may include one or more of a first icon 428, a second icon 430, and/or other icons. The number of icons may vary across specific implementations. One or more of the graphical icons may include static icons, dynamic icons, application icons, and/or other types of graphical icons. By way of non-limiting example, the first icon 428 and second icon 430 may comprise static and/or dynamic icons associated with one or more applications.

First assembly field 418 may be configured to reflect entered and/or selected messaging content by a user via the first entry field 426. The first assembly field 418 may display an assembly of the entered and/or selected messaging content based on sequential entry and/or selection of the messaging content by a user. By way of non-limiting example, the user may type in a character string (e.g., one or more symbols, words, sentences, and/or phrases) using a keyboard-type entry mechanism in the first entry field 426 (not shown in FIG. 4). The first assembly field 418 may be configured to display the string as individual characters are entered and/or selected. In some implementations, the user may provide input to select a graphical icon. The entry and/or selection may be represented by an instance of the graphical icon appearing in the assembly field 418. In some implementations, the user may finalize their entry and/or selection by submitting the content for display in the first messaging feed 408. By way of non-limiting example, a user may enter and/or selection a “send” interface element included in the first assembly field 418 configured to facilitate displaying content into the first messaging feed 408.

In some implementations, the first communication field 406 may be configured to display a first messaging feed 408. The first messaging feed 408 may reflect a communication session between the first computing platform and one or more other computing platforms. The messaging feed 408 may include messaging content. The messaging content may include content previously entered and/or selected by a first user of the first computing platform through one or both of the first entry field 426 or the first assembly field 418. The first messaging feed 408 may include messaging content 412 entered and/or selected by the first user of the first computing platform.

The first messaging feed 408 may include messaging content previously entered and/or selected by one or more other users through the one or more other computing platforms. The first messaging feed 408 may include other messaging content 412 entered and/or selected by other users through one or more other computing platforms. In some implementations, the respective messaging content entered by the users may be represented by separate chat bubbles within the first messaging feed 408, and/or may be distinguished in other ways.

By way of non-limiting illustration in FIG. 3, the messaging component 125 may be configured to effectuate presentation of a first messaging interface 302. The first messaging interface 302 may include a first entry field 304, a first assembly field 306, a first communication field 308, and/or other fields. The first communication field 308 may display a first messaging feed 310 reflecting a communication session between the computing platform 118 and one or more other computing platforms (not shown in FIG. 3).

Returning to FIG. 1, the updating component 126 may be configured to receive entry and/or selection of messaging content from a user of the computing platform 118. By way of non-limiting example, the updating component 126 may be configured to receive entry and/or selection of messaging content via one or more input mechanisms included in or coupled to the computing platform 118.

In some implementations, the updating component 126 may be configured to update a messaging feed of a communication field presented on the computing platform 118. The messaging feed may be updated to present instances of the entered and/or selected messaging content. By way of non-limiting example, a user may select a graphical icon from an entry field of the messaging interface. The messaging feed may be updated to include an instance of the graphical icon.

In some implementations, the updating component 126 may be configured to update a messaging feed presented on the computing platform 118 to include messaging content entered and/or selected by one or more other users of one or more other computing platforms that share a communication session with the computing platform 118. By way of non-limiting example, the updating component 126 may be configured to receive information describing messaging content entered and/or selected by the one or more other users. Based on the received information, the updating component 126 may be configured to receive information describing messaging content over network 116. The updating component 126 may be configured to determine the messaging content entered and/or selected by the other users and present instances of the messaging content in the messaging feed. In some implementations, the received information may include information identifying the user and/or computing platform associated with the user who entered and/or selected the messaging content. The updating component 126 may be configured to update a messaging feed such that incoming messaging content may be presented in accordance with an appropriate sending user.

In some implementations, the updating component 126 may be configured to communicate information describing the messaging content entered and/or selected by a user if the computing platform 118 to facilitate updating messaging feeds of other computing platforms sharing a communication session. The communicated information may include information identifying one or both of the sending computing platform and/or user associated with the entry and/or selection.

In some implementations, the updating component 126 may send and/or receive information over network 116. In some implementations, the information sent and/or received by the updating component 126 may include information routed to and/or from the server 102, external resource 120, and/or other entities. In some implementations, information sent and/or received by the updating component 126 may include information routed to and/or from a cell network and/or corresponding entities, a local area network and/or corresponding entities, and/or other networks and/or entities.

By way of non-limiting illustration in FIG. 3, the updating component 126 may be configured to receive entry and/or selection of first messaging content 314 from a user of the computing platform 118. The updating component 126 may be configured to effectuate a first update 316 of the first messaging feed 310. The first update 316 may correspond to presenting a first instance of the first messaging content 314 in the first messaging feed 310. In some implementations, the updating component 126 may be configured to communicate first messaging information 318 describing the first messaging content 314 to facilitate updating other messaging feeds of other computing platforms sharing a communication session with the computing platform 118.

In some implementations, the updating component 126 may be configured to obtain information describing messaging content entered and/or selected by one or more other users through one or more other computing platforms. By way of non-limiting example, the updating component 126 may be configured to receive information describing second messaging content 320 entered and/or selected by a second user (not shown in FIG. 3) via a second computing platform (not shown in FIG. 3). The computing platform 118 and/or second computing platform may be associated with a communication session. The updating component 126 may be configured to effectuate a second update 322 of the first messaging feed 310 to present an instance of the second messaging content 320 based on the obtained information. In some implementations, the second update 322 may comprise scrolling the presented instance of the first messaging content 314 from a first position on the first messaging feed 310 to a different position. Scrolling may comprise moving messaging content from a first position in the messaging feed to a second position in the messaging feed. Messaging content may be presented in the messaging feeds in other ways.

Returning to FIG. 1, the application interaction component 128 may be configured to facilitate interactions with mobile applications via messaging interfaces. In some implementations, the application interaction component 128 may facilitate downloading (or otherwise obtaining) a special keyboard to a computing platform. The special keyboard may include individual ones of the one or more icons including an application-type icon. The special keyboard may be configured to facilitate entry and/or selection of messaging content via the entry field of the messaging interface.

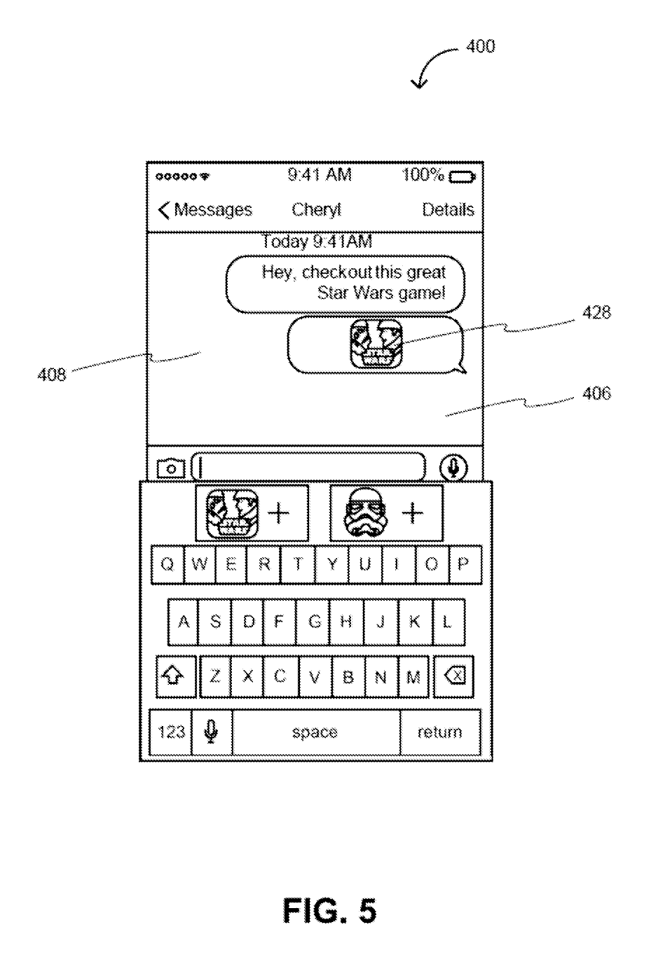

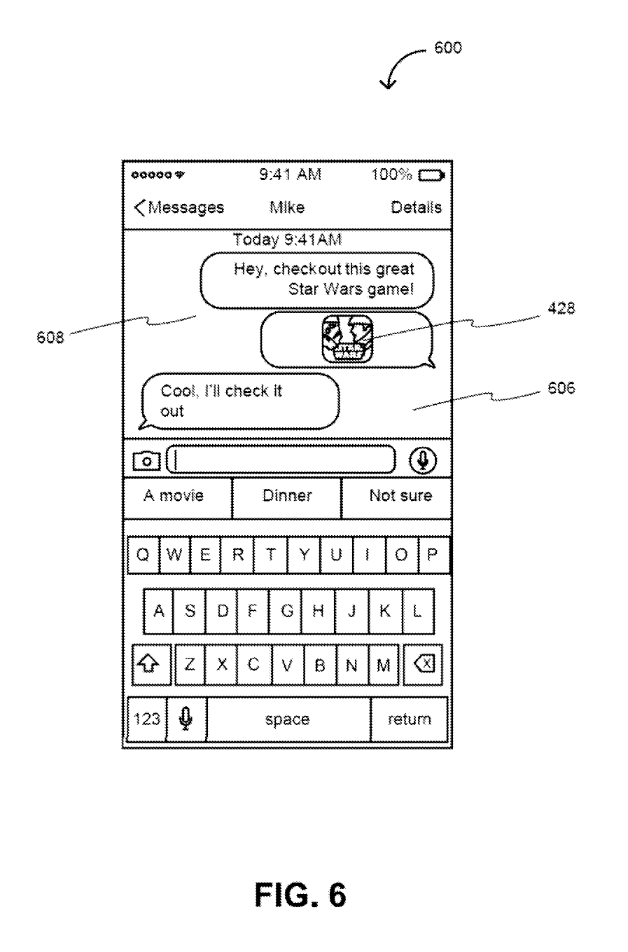

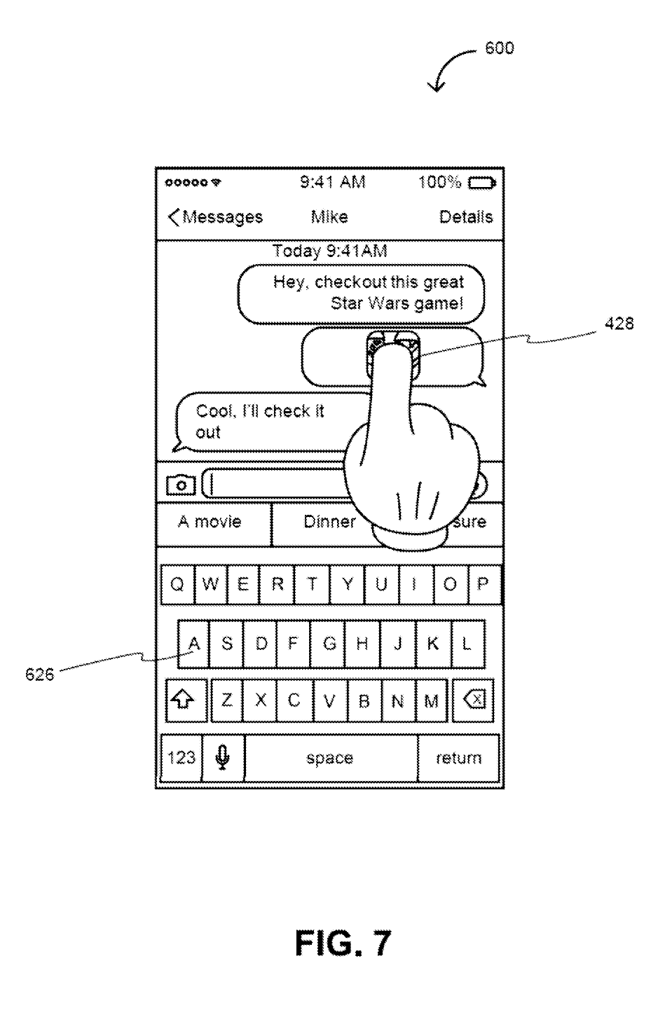

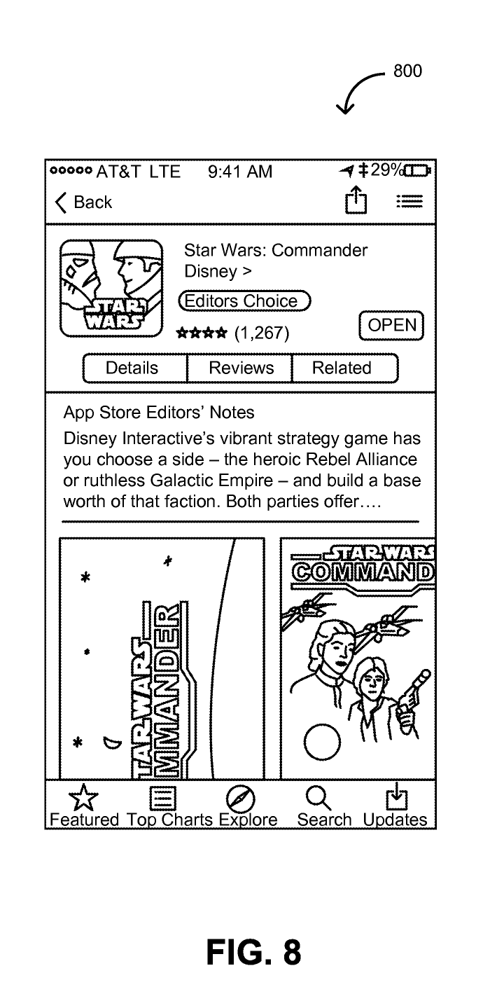

By way of non-limiting illustration, FIGS. 4-8 convey an exemplary implementation. In FIG. 4, the first icon 428 is selected by a first user (e.g., Cheryl) via the entry field 426 of the first computing platform. In FIG. 5, the first icon 428 is shown in the messaging feed 408 of the communication field 406. FIG. 6 illustrates an exemplary implementation of a messaging interface 600 of a second computing platform. The first computing platform and the second computing platform may be engaged in a communication session via the messaging interface 400 of the first computing platform and the messaging interface 600 of the second computing platform. As shown in FIG. 6, responsive to the first icon 428 being selected and displayed via messaging interface 400, the first icon 428 is displayed in a messaging feed 608 of a communication field 606 of the messaging interface 600. In FIG. 7, the first icon 428 is selected by a second user (e.g., Mike) via the messaging feed 608 of the communication field 606 of the messaging interface 600 of the second computing platform. An entry field 626 of the messaging interface 600 may be devoid of the first icon 428. Responsive to the first icon 428 being selected via the second computing platform, an interaction with a mobile application may occur. For example, FIG. 8 illustrates an exemplary implementation of an application interface 800 that may be presented via the second computing platform responsive to selection of the first icon 420 by the second user. The type of interaction with the mobile application may vary for different implementations.

In some implementations, the interaction with the mobile application may include presentation of a specific location in the mobile application via the second computing platform. Such interaction may be facilitated by a deep link associated with first icon 428. The first icon 428 may include or point to a uniform resource identifier (URI) that links to a specific location within a mobile application. In FIG. 8, for example, a specific location (e.g., the Star Wars Commander page) may be presented via a specific mobile application (e.g., an App Store application) responsive to selection of the first icon 428 via the second computing platform.

In some implementations, the interaction with the mobile application may include effectuating an action within the mobile application. Examples of actions effectuated may include one or more of performing a game action, effectuating a social media interaction, inviting a user to install an application, and/or other actions. Examples of game actions may include one or more of sending troops, providing in-game gifts, participating in in-game chat, joining or leaving a squadron, conveying lives, conveying moves and/or other game actions. Examples of social media interactions may include one or more of an invitation to connect, an invitation to follow, an invitation to form a social media relationship (e.g., Facebook friends), sharing an image or video of gameplay, and/or other social media interactions. In some implementations, the interaction with the mobile application may include receiving virtual currency and/or a virtual item via the mobile application.

In some implementations, the action within the mobile application may be executed responsive to the mobile application being opened on the second computing platform. For example, responsive to selection of the first icon 428 via the second computing platform, a corresponding mobile application may be opened on the second computing platform such that the action can be effectuated. In some implementations, opening the corresponding mobile application may occur automatically upon selection of the first icon 428 via the second computing platform. In some implementations, the corresponding mobile application may be opened manually at the second users discretion and then only after the application is manually opened with the action be effectuated. In some implementations, user may have the optionally select whether the corresponding application is opened automatically or manually.

In some implementations, effectuation of the interaction with the mobile application may be agnostic to a type of operating system running on the second computing platform. By way of non-limiting example, the first computing platform may be running Apple iOS and the second computing platform may be running Android OS. In some implementations, a deep link may be generic and work with any operating system. In some implementations, the operating system may be detected such that selection of the first icon 428 provides the correct result.

By way of non-limiting illustration in FIG. 3, the application interaction component 128 may be configured to facilitate interaction 330, interaction 332, interaction 334, and/or other interactions. Individual ones of interactions 330, 332, 334, and/or other interactions may be associated with individual mobile applications available on one or more computing platforms.

Returning to FIG. 1, server 102 may include one or more physical processors 104 configured to execute machine-readable instructions 105. The machine-readable instructions 105 may be stored in electronic storage 114, and/or other storage location. The machine-readable instructions 105 may include one or more of a user component 106, a receiving component 107, an updating component 108, an application interaction component 110, and/or other components. The machine-readable instructions 105 may be executable by processor(s) 104 to facilitate interactions with mobile applications via messaging interfaces.

In some implementations, the user component 106 may be configured to access and/or manage one or more user profiles and/or user information associated with users of the computing platforms 118. The one or more user profiles and/or user information may include information stored by one or more computing platforms 118, server 102, and/or other storage locations. By way of non-limiting example, the user component 106 may access and/or manage information stored by the user components 124 of the computing platforms 118. In some implementations, the same or similar information may persist between the user components 124 of computing platforms 118 and user component 106 of server 102.

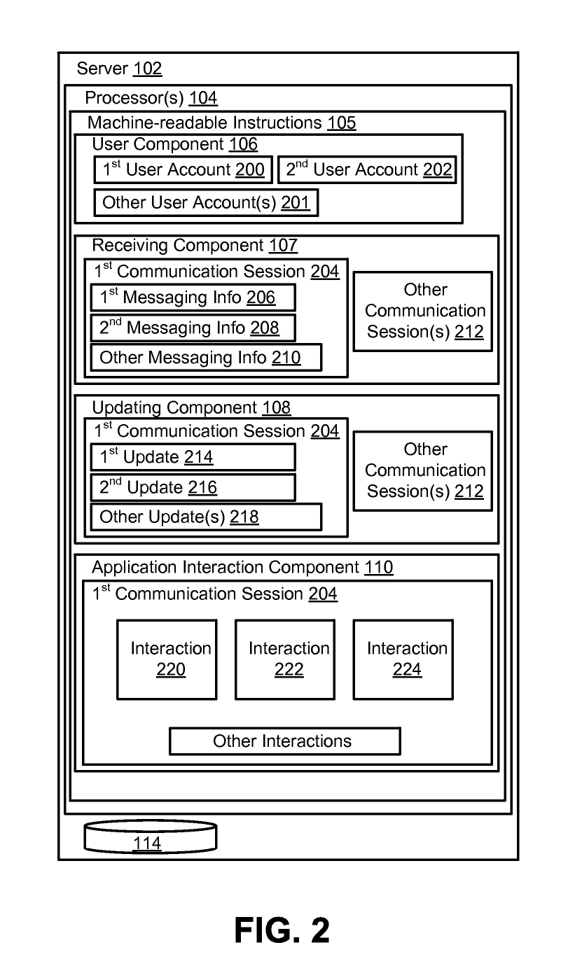

By way of non-limiting illustration in FIG. 2, the user component 106 may be configured to manage a first user account 200 associated with one or more users of a first computing platform (not shown in FIG. 2). The user component 106 may be configured to manage a second user account 202 associated with one or more users of a second computing platform (not shown in FIG. 2). The user component 106 may be configured to manage other user account(s) 201 associated with one or more other users of one or more other computing platforms.

Returning to FIG. 1, the receiving component 107 may be configured to receive messaging information describing messaging content entered and/or selected by users through computing platforms 118 associated with communication sessions. The messaging content may be entered and/or selected by users via messaging interfaces presented at the computing platforms 118 (see, e.g., messaging component 125 described herein).

In some implementations, messaging information describing messaging content may include information identifying a user and/or computing platform sending the messaging content, one or more users and/or computing platforms intended as recipients of the messaging content in accordance with a communication session, and/or other information. In some implementations, information describing messaging content may include information used to look up the messaging content from a database of messaging content. By way of non-limiting example, messaging information describing messaging content may include keys, identifiers, pointers, network addresses, and/or other information used by the receiving component 107 to look up the corresponding messaging content. By way of non-limiting illustration, users may enter and/or select messaging content at a computing platform. The computing platform may communicate, to the server 102, identifiers that point to what the corresponding messaging content is. The identifiers and/or other messaging information may be received by the receiving component 107.

In some implementations, messaging information describing messaging content may include the messaging content and/or a representation (e.g., a copy) of the messaging content. By way of non-limiting example, messaging information describing messaging content may include messaging content and/or a copy of messaging content entered and/or selected by a user a computing platform. By way of non-limiting illustration, users may enter and/or select messaging content at a computing platform. The computing platform may communicate, to the server 102, a copy of the messaging content. The copy may be received by the receiving component 107.

By way of non-limiting illustration in FIG. 2, the receiving component 107 may be configured to receive first messaging information 206 describing first messaging content entered and/or selected by a first user through a first computing platform. The first computing platform may be associated with a first communication session 204. The receiving component 107 may be configured to receive second messaging information 208 describing second messaging content entered and/or selected by a second user through a second computing platform. The second computing platform may be associated with the first communication session 204. The receiving component 107 may be configured to receive other messaging information 210 describing messaging content entered and/or selected by the first user, second user, and/or other users through one or more computing platforms. The receiving component 107 may be configured to receive information describing messaging content entered and/or selected by users through computing platforms associated with other communication sessions 212.

Returning to FIG. 1, the updating component 108 may be configured to effectuate updates of messaging feeds of messaging interfaces presented on the computing platforms based on the received messaging information. The updating component 108 may be configured such that updates may correspond to presenting instances of messaging content in the messaging feeds. In some implementations, effectuating updates may comprise communicating, to recipient computing platforms within a communication session, messaging information describing messaging content to be presented in a messaging feed of a messaging interface presented at the recipient computing platforms 118. In some implementations, the communicated messaging information may comprise the messaging information received by the receiving component 107. By way of non-limiting example, the server 102 may relay messaging content and/or information describing messaging content between computing platform within a communication session.

By way of non-limiting illustration in FIG. 2, the updating component 108 may be configured to effectuate a first update 214 of a first messaging feed presented on a first computing platform based on the received second messaging information 208. The first update 214 may correspond to presenting an instance of the second messaging content in the first messaging feed. The first update 214 may include communicating messaging information describing the second messaging content to the first computing platform.

In some implementations, the updating component 108 may be configured to effectuate a second update 216 of a second messaging feed presented on a second computing platform based on the received first messaging information 206. The second update 216 may correspond to presenting an instance of the first messaging content on the second messaging feed. The second update 216 may include communicating messaging information describing the first messaging content to the second computing platform. The updating component 108 may be configured to effectuate other updates 218 of other messaging feeds of other computing platforms associated with the first communication session 204.

Returning to FIG. 1, the application interaction component 110 may be configured to facilitate interactions with mobile applications via messaging interfaces. In some implementations, the application interaction component 110 may be configured to facilitate downloading (or otherwise obtaining) a special keyboard to a computing platform. The special keyboard may include individual ones of the one or more icons including an application-type icon. The special keyboard may be configured to facilitate entry and/or selection of messaging content via the entry field of the messaging interface.

By way of non-limiting illustration in FIG. 2, the application interaction component 110 may be configured to facilitate interaction 220, interaction 222, interaction 224, and/or other interactions. Individual ones of interactions 220, 222, 224, and/or other interactions may be associated with individual mobile applications available on one or more computing platforms.

By way of non-limiting illustration in FIG. 2, the receiving component 107 may be configured to receive entry and/or selection of messaging content. The first user may be associated with a first computing platform. A second user may be associated with a second computing platform. The first and second computing platforms may be associated by the first communication session 204. The updating component 108 may be configured to effectuate an update of the messaging feeds of the first computing platform and second computing platform.

Returning to FIG. 1, server 102, computing platforms 118, and/or external resources 120 may be operatively linked via one or more electronic communication links. For example, such electronic communication links may be established, at least in part, via a network (e.g., network(s) 116) such as the Internet and/or other networks. It will be appreciated that this is not intended to be limiting, and that the scope of this disclosure includes implementations in which server 102, computing platforms 118, and/or external resources 120 may be operatively linked via some other communication media.

The external resources 120 may include sources of information that are outside of system 100, external entities participating with system 100, and/or other resources. In some implementations, some or all of the functionality attributed herein to external resources 120 may be provided by resources included in system 100.

Computing platforms 118 may include electronic storage 132, one or more processors 122, and/or other components. Computing platforms 118 may include communication lines or ports to enable the exchange of information with a network, a server, and/or other computing platforms. Illustration of computing platforms 118 in FIG. 1 is not intended to be limiting. Computing platforms 118 may include a plurality of hardware, software, and/or firmware components operating together to provide the functionality attributed herein to computing platforms 118.

Server 102 may include electronic storage 114, one or more processors 104, and/or other components. Server 102 may include communication lines or ports to enable the exchange of information with a network and/or other computing platforms. Illustration of server 102 in FIG. 1 is not intended to be limiting. The server 102 may include a plurality of hardware, software, and/or firmware components operating together to provide the functionality attributed herein to server 102. For example, server 102 may be implemented by a cloud of computing platforms operating together as server 102.

Electronic storage 114 and/or 132 may comprise electronic storage media that electronically stores information. The electronic storage media of the electronic storage 114 and/or 132 may include one or both of storage that is provided integrally (i.e., substantially non-removable) with the respective device and/or removable storage that is removably connectable to the respective device. Removable storage may include, for example, a port or a drive. A port may include a USB port, a firewire port, and/or other port. A drive may include a disk drive and/or other drive. Electronic storage 114 and/or 132 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage may include one or more virtual storage resources (e.g., cloud storage, a virtual private network, and/or other virtual storage resources). Electronic storage 114 and/or 132 may store files, software algorithms, information determined by processor(s) 104 and/or 122, respectively, and/or other information that enables the respective devices to function as described herein.

Processor(s) 104 is configured to provide information-processing capabilities in the server 102. As such, processor(s) 104 may include one or more of a digital processor, an analog processor, a digital circuit designed to process information, an analog circuit designed to process information, a state machine, and/or other mechanisms for electronically processing information. Although the processor(s) 104 are shown in FIG. 1 as single entity within the server 102, this is for illustrative purposes only. In some implementations, the processor(s) 104 may include one or more processing units. These processing units may be physically located within the same device or may represent processing functionality of a plurality of devices operating in coordination.

For example, processor(s) 104 may be configured to execute components 106, 107, 108, and/or 110. Processor(s) 104 may be configured to execute components 106, 107, 108, and/or 110 by software; hardware; firmware; some combination of software, hardware, and/or firmware; and/or other mechanisms for configuring processing capabilities on processor 104. It should be appreciated that, although components 106, 107, 108, and/or 110 are illustrated in FIG. 1 as being co-located within a single processing unit, in implementations in which processor 104 includes multiple processing units, one or more of components 106, 107, 108, and/or 110 may be located remotely from the other components. The description of the functionality provided by the different components 106, 107, 108, and/or 110 described above is for illustrative purposes and is not intended to be limiting, as any of components 106, 107, 108, and/or 110 may provide more or less functionality than is described. For example, one or more of components 106, 107, 108, and/or 110 may be eliminated, and some or all of its functionality may be provided by other ones of components 106, 108, 110, and/or other components.

Processor(s) 122 are configured to provide information-processing capabilities in the computing platforms 118. As such, processor(s) 122 may include one or more of a digital processor, an analog processor, a digital circuit designed to process information, an analog circuit designed to process information, a state machine, and/or other mechanisms for electronically processing information. Although the processor(s) 122 are shown in FIG. 1 as a single entity within the computing platform 118, this is for illustrative purposes only. In some implementations, the processor(s) 122 may include one or more processing units. These processing units may be physically located within the same device or may represent processing functionality of a plurality of devices operating in coordination.

For example, processor(s) 122 may be configured to execute components 124, 125, 126, and/or 128. Processor(s) 122 may be configured to execute components 124, 125, 126, and/or 128 by software; hardware; firmware; some combination of software, hardware, and/or firmware; and/or other mechanisms for configuring processing capabilities on processor 122. It should be appreciated that, although components 124, 125, 126, and/or 128 are illustrated in FIG. 1 as being co-located within a single processing unit, in implementations in which processor(s) 122 includes multiple processing units, one or more of components 124, 125, 126, and/or 128 may be located remotely from the other components. The description of the functionality provided by the different components 124, 125, 126, and/or 128 described above is for illustrative purposes and is not intended to be limiting, as any of components 124, 125, 126, and/or 128 may provide more or less functionality than is described. For example, one or more of components 124, 125, 126, and/or 128 may be eliminated, and some or all of its functionality may be provided by other ones of components 124, 125, 126, 128, and/or other components.

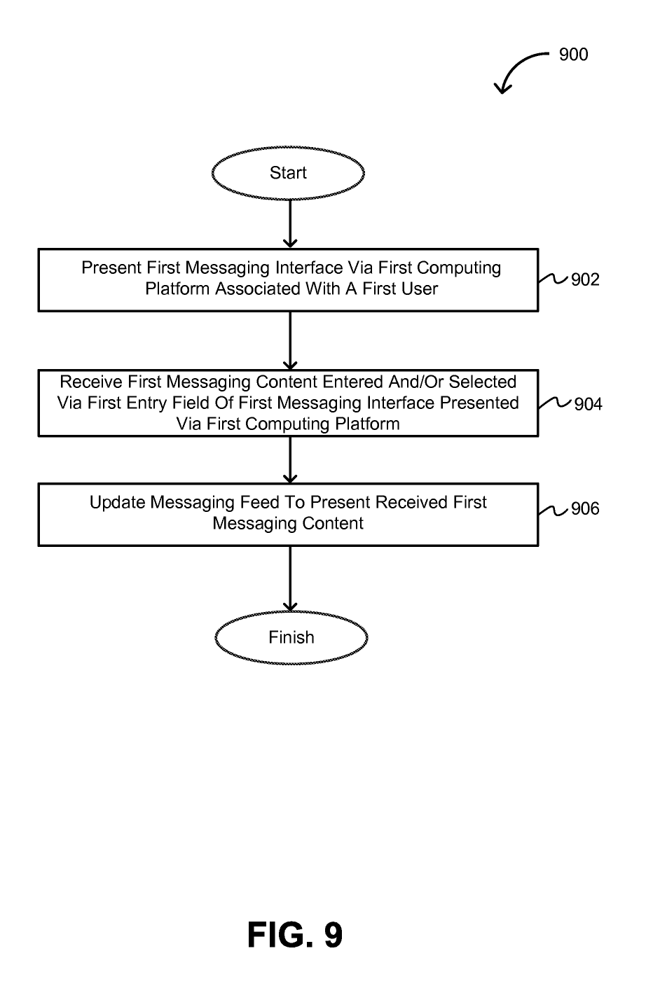

FIG. 9 illustrates a method 900 for facilitating interactions with mobile applications via messaging interfaces, in accordance with one or more implementations. The operations of method 900 presented below are intended to be illustrative. In some implementations, method 900 may be accomplished with one or more additional operations not described and/or without one or more of the operations discussed. Additionally, the order in which the operations of method 900 are illustrated in FIG. 9 and described below is not intended to be limiting.

In some implementations, method 900 may be implemented in one or more processing devices (e.g., a computing platform, a digital processor, an analog processor, a digital circuit designed to process information, an analog circuit designed to process information, a state machine, and/or other mechanisms for electronically processing information) and/or one or more other components. The one or more processing devices may include one or more devices executing some or all of the operations of method 900 in response to instructions stored electronically on an electronic storage medium. The one or more processing devices may include one or more devices configured through hardware, firmware, and/or software to be specifically designed for execution of one or more of the operations of method 900.

At an operation 902, a first messaging interface may be presented via a first computing platform associated with a first user. The first messaging interface may include a first entry field and a first communication field. The first entry field may display first messaging content available for entry and/or selection by the first user. The first communication field may display a messaging feed that reflects a communication session between the first computing platform and a second computing platform associated with a second user. The second computing platform may present a second messaging interface including a second communication field displaying the messaging feed. The communication session may include first messaging content previously entered and/or selected by the first user via the entry field and second messaging content previously entered and/or selected via the second computing platform. In some implementations, operation 902 may be performed by a messaging component that is the same as or similar to messaging component 125 (shown in FIG. 1 and described herein).

At an operation 904, first messaging content entered and/or selected via the first entry field of the first messaging interface presented via the first computing platform may be received. In some implementations, operation 904 may be performed by a receiving component that is the same as or similar to receiving component 107 (shown in FIG. 1 and described herein).

At an operation 906, the messaging feed may be updated to present the received first messaging content. The updated messaging feed may be displayed via the first communication field of the first computing platform and the second communication field of the second computing platform. In some implementations, operation 906 may be performed by an updating component that is the same as or similar to updating component 108 and/or updating component 126 (shown in FIG. 1 and described herein).

According to some implementations of method 900, the first messaging content available for entry and/or selection by the first user may include one or more icons including a first icon. The first icon may be selectable by the second user via the messaging feed displayed via the second communication field of the second computing platform. Selection of the first icon via the messaging feed displayed via the second communication field of the second computing platform may effectuate an interaction with a mobile application occurring on the second computing platform.

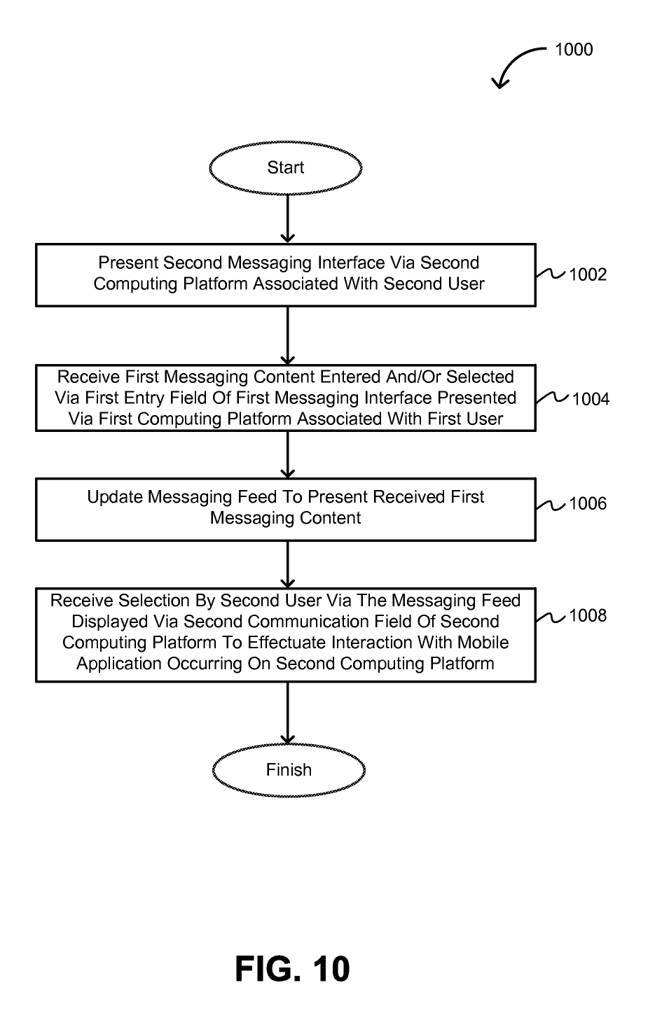

FIG. 10 illustrates a method 1000 for facilitating interactions with mobile applications via messaging interfaces, in accordance with one or more implementations. The operations of method 1000 presented below are intended to be illustrative. In some implementations, method 1000 may be accomplished with one or more additional operations not described and/or without one or more of the operations discussed. Additionally, the order in which the operations of method 1000 are illustrated in FIG. 10 and described below is not intended to be limiting.

In some implementations, method 1000 may be implemented in one or more processing devices (e.g., a computing platform, a digital processor, an analog processor, a digital circuit designed to process information, an analog circuit designed to process information, a state machine, and/or other mechanisms for electronically processing information) and/or one or more other components. The one or more processing devices may include one or more devices executing some or all of the operations of method 1000 in response to instructions stored electronically on an electronic storage medium. The one or more processing devices may include one or more devices configured through hardware, firmware, and/or software to be specifically designed for execution of one or more of the operations of method 1000.

At an operation 1002, a second messaging interface may be presented via a second computing platform associated with a second user. The second messaging interface may include a second entry field and a second communication field. The second entry field may display second messaging content available for entry and/or selection by the second user. The second communication field may display a messaging feed that reflects a communication session between the second computing platform and a first computing platform associated with a first user. The first computing platform may present a first messaging interface including a first entry field displaying first messaging content available for entry and/or selection by the first user. The communication session may include first messaging content previously entered and/or selected by the first user via the first entry field and second messaging content previously entered and/or selected via the second entry field. In some implementations, operation 1002 may be performed by a messaging component that is the same as or similar to messaging component 125 (shown in FIG. 1 and described herein).

At an operation 1004, first messaging content entered and/or selected via the first entry field of the first messaging interface presented via the first computing platform may be received. In some implementations, operation 1004 may be performed by a receiving component that is the same as or similar to receiving component 107 (shown in FIG. 1 and described herein).

At an operation 1006, the messaging feed may be updated to present the received first messaging content. The updated messaging feed may be displayed via the second communication field of the second computing platform and first second communication field of the first computing platform. The first messaging content available for entry and/or selection by the first user may include one or more icons including a first icon. The second messaging content available for entry and/or selection by the second user may be devoid of the first icon. In some implementations, operation 1006 may be performed by an updating component that is the same as or similar to updating component 108 and/or updating component 126 (shown in FIG. 1 and described herein).

At an operation 1008, a selection by the second user may be received via the messaging feed displayed via the second communication field of the second computing platform. Selection of the first icon via the messaging feed displayed via the second communication field of the second computing platform may effectuate an interaction with a mobile application occurring on the second computing platform. In some implementations, operation 1008 may be performed by an application interaction component that is the same as or similar to application interaction component 110 and/or application interaction component 128 (shown in FIG. 1 and described herein).

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A non-transitory machine-readable storage medium having instructions embodied thereon, the instructions being executable by one or more hardware processors to perform a method for facilitating interactions with mobile applications via messaging interfaces, the method comprising:
presenting a first messaging interface via a first computing platform associated with a first user, the first messaging interface including a first entry field and a first communication field, the first entry field displaying first messaging content available for entry and/or selection by the first user, the first communication field displaying a messaging feed that reflects a communication session between the first computing platform and a second computing platform associated with a second user, the second computing platform presenting a second messaging interface including a second communication field displaying the messaging feed, the communication session including first messaging content previously entered and/or selected by the first user via the entry field and second messaging content previously entered and/or selected via the second computing platform;
receiving first messaging content entered and/or selected via the first entry field of the first messaging interface presented via the first computing platform; and
updating the messaging feed to present the received first messaging content, the updated messaging feed being displayed via the first communication field of the first computing platform and the second communication field of the second computing platform;
wherein the first messaging content available for entry and/or selection by the first user includes one or more icons including a first icon, the first icon being selectable by the second user via the messaging feed displayed via the second communication field of the second computing platform, selection of the first icon via the messaging feed displayed via the second communication field of the second computing platform effectuating an interaction with a mobile application occurring on the second computing platform.

2. The storage medium of claim 1, wherein the method further comprises downloading a special keyboard to the first computing platform, the special keyboard including individual ones of the one or more icons including the first icon, the special keyboard being configured to facilitate entry and/or selection of the first messaging content via the first entry field of the first messaging interface.

3. The storage medium of claim 1, wherein the second messaging interface presented by the second computing platform further includes a second entry field, the second entry field displaying second messaging content available for entry and/or selection by the second user, the second messaging content being devoid of the first icon.

4. The storage medium of claim 1, wherein the interaction with the mobile application includes downloading a special keyboard to the second computing platform, the special keyboard including individual ones of the one or more icons including the first icon, the special keyboard being configured to facilitate entry and/or selection of messaging content via the second entry field of the second messaging interface.

5. The storage medium of claim 1, wherein the interaction with the mobile application includes presentation of a specific location in the mobile application via the second computing platform.

6. The storage medium of claim 1, wherein the interaction with the mobile application includes effectuating an action within the mobile application.

7. The storage medium of claim 6, wherein the action within the mobile application is executed responsive to the mobile application being opened on the second computing platform.

8. The storage medium of claim 1, wherein the interaction with the mobile application includes receiving virtual currency and/or a virtual item via the mobile application.

9. The storage medium of claim 1, wherein the mobile application is an app store application, the interaction with the mobile application including opening and displaying a specific app page within the app store application.

10. The storage medium of claim 1, wherein effectuation of the interaction with the mobile application is agnostic to a type of operating system running on the second computing platform.

11. A non-transitory machine-readable storage medium having instructions embodied thereon, the instructions being executable by one or more hardware processors to perform a method for facilitating interactions with mobile applications via messaging interfaces, the method comprising:
presenting a second messaging interface via a second computing platform associated with a second user, the second messaging interface including a second entry field and a second communication field, the second entry field displaying second messaging content available for entry and/or selection by the second user, the second communication field displaying a messaging feed that reflects a communication session between the second computing platform and a first computing platform associated with a first user, the first computing platform presenting a first messaging interface including a first entry field displaying first messaging content available for entry and/or selection by the first user, the communication session including first messaging content previously entered and/or selected by the first user via the first entry field and second messaging content previously entered and/or selected via the second entry field;
receiving first messaging content entered and/or selected via the first entry field of the first messaging interface presented via the first computing platform;
updating the messaging feed to present the received first messaging content, the updated messaging feed being displayed via the second communication field of the second computing platform and first second communication field of the first computing platform, wherein the first messaging content available for entry and/or selection by the first user includes one or more icons including a first icon, and wherein the second messaging content available for entry and/or selection by the second user is devoid of the first icon; and
receiving a selection by the second user via the messaging feed displayed via the second communication field of the second computing platform, selection of the first icon via the messaging feed displayed via the second communication field of the second computing platform effectuating an interaction with a mobile application occurring on the second computing platform.

12. The storage medium of claim 11, wherein the interaction with the mobile application includes presentation of a specific location in the mobile application via the second computing platform.

13. The storage medium of claim 11, wherein the interaction with the mobile application includes effectuating an action within the mobile application.

14. The storage medium of claim 13, wherein the action within the mobile application is executed responsive to the mobile application being opened on the second computing platform.

15. The storage medium of claim 11, wherein the interaction with the mobile application includes receiving virtual currency and/or a virtual item via the mobile application.

16. The storage medium of claim 11, wherein the mobile application is an app store application, the interaction with the mobile application including opening and displaying a specific app page within the app store application.

17. The storage medium of claim 11, wherein effectuation of the interaction with the mobile application is agnostic to a type of operating system running on the second computing platform.

18. A system configured for facilitating interactions with mobile applications via messaging interfaces, the system comprising:
one or more hardware processors configured by machine-readable instructions to:
provide a first messaging interface for presentation via a first computing platform associated with a first user, the first messaging interface including a first entry field and a first communication field, the first entry field displaying first messaging content available for entry and/or selection by the first user, the first communication field displaying a messaging feed that reflects a communication session between the first computing platform and a second computing platform associated with a second user, the second computing platform presenting a second messaging interface including a second communication field displaying the messaging feed, the communication session including first messaging content previously entered and/or selected by the first user via the entry field and second messaging content previously entered and/or selected via the second computing platform;
receive first messaging content entered and/or selected via the first entry field of the first messaging interface presented via the first computing platform; and
update the messaging feed to present the received first messaging content, the updated messaging feed being displayed via the first communication field of the first computing platform and the second communication field of the second computing platform;
wherein the first messaging content available for entry and/or selection by the first user includes one or more icons including a first icon, the first icon being selectable by the second user via the messaging feed displayed via the second communication field of the second computing platform, selection of the first icon via the messaging feed displayed via the second communication field of the second computing platform effectuating an interaction with a mobile application occurring on the second computing platform.

19. The system of claim 18, wherein the one or more hardware processors are further configured by machine-readable instructions to provide a special keyboard for download to the first computing platform, the special keyboard including individual ones of the one or more icons including the first icon, the special keyboard being configured to facilitate entry and/or selection of the first messaging content via the first entry field of the first messaging interface.

20. The system of claim 18, wherein the second messaging interface presented by the second computing platform further includes a second entry field, the second entry field displaying second messaging content available for entry and/or selection by the second user, the second messaging content being devoid of the first icon.

21. The system of claim 18, wherein the interaction with the mobile application includes downloading a special keyboard to the second computing platform, the special keyboard including individual ones of the one or more icons including the first icon, the special keyboard being configured to facilitate entry and/or selection of messaging content via the second entry field of the second messaging interface.

22. The system of claim 18, wherein the interaction with the mobile application includes presentation of a specific location in the mobile application via the second computing platform.

23. The system of claim 18, wherein the interaction with the mobile application includes effectuating an action within the mobile application.

24. The system of claim 23, wherein the action within the mobile application is executed responsive to the mobile application being opened on the second computing platform.

25. The system of claim 18, wherein the interaction with the mobile application includes receiving virtual currency and/or a virtual item via the mobile application.

26. The system of claim 18, wherein the mobile application is an app store application, the interaction with the mobile application including opening and displaying a specific app page within the app store application.

27. The system of claim 18, wherein effectuation of the interaction with the mobile application is agnostic to a type of operating system running on the second computing platform.
